(19) United States
(12) Patent Application Publication
(10) Pub. No.: US 2010/0013634 A1
(43) Pub. Date: Jan. 21, 2010

(54) DISTRIBUTED SYSTEMS MONITORING SYSTEM

(76) Inventor: Yoshihiro Kanna, Tokyo (JP)

Correspondence Address: Mr. Jackson Chen, 6535 N. STATE HWY 161, IRVING, TX, 75039, US

(21) Appl. No.: 12/529,446

(22) PCT Filed: Mar. 25, 2008
(86) PCT No.: PCT/JP2008/055541

§ 371 Date: Sep. 1, 2009

(30) Foreign Application Priority Data
Mar. 28, 2007 (JP) 2007-084568

(51) Int. Cl. G08B 21/00

(52) U.S. Cl. 340/540

(57) ABSTRACT

Disclosed is a distributed systems monitoring system comprising information monitoring units for acquiring monitoring information from monitoring targets, and a monitoring information collecting and integrating unit for integrating the monitoring information acquired from the information monitoring units and for presenting the integrated monitoring information to a user. Upon receipt of monitoring information from the monitoring target, the information monitoring unit determines whether or not the monitoring information has a high degree of urgency. If the information has a high degree of urgency, then the monitoring information is notified to the monitoring information collecting and integrating unit. Otherwise, the monitoring information is stored in a monitoring information holding section, and is transmitted each time a monitoring information request is received from the monitoring information collecting and integrating unit. Upon receipt of urgent monitoring information, the monitoring information collecting and integrating unit integrates the urgent monitoring information with general monitoring information that became available by the time when the urgent monitoring information became available and notifies the user of the information. The monitoring information collecting and integrating unit transmits on a regular basis a general monitoring information transmit request to the information monitoring unit. Upon receipt of general monitoring information, the monitoring information collecting and integrating unit integrates the general monitoring information in the information monitoring unit, stores the general monitoring information in an integrated monitoring holding section and presents the general monitoring information held in the integrated monitoring information holding section to the user by request.

### TECHNICAL FIELD

The present invention relates to a system for monitoring operations of systems, and more particularly to a distributed systems monitoring system for monitoring the operations of distributed systems wherein a plurality of systems operate in a coordinated manner.

### BACKGROUND OF THE INVENTION

An example of a related distributed systems monitoring system of this kind is described in Patent document 1.

FIG. 1 illustrates the configuration of a sensor module that constitutes part of the distributed systems monitoring system. This sensor module comprises: power feeding section 501 which is a power supply; application section 502 which acts as a sunshine recorder; communication processing section 503 which communicates with a radio base station and other sensor modules; power supply control section 504 which controls the supply of power to application section 502 and to communication processing section 503, and clock circuit 504 which provides time information.

The related distributed systems monitoring system having such a configuration transmits observation information obtained from observation equipment (not shown) to the base station each time power feeding section 501 supplies power to communication processing section 503.

Patent document 1: JP2005-135289A

### DISCLOSURE OF THE INVENTION

### Problems to be Solved by the Invention

A monitoring system for transmitting monitoring information on a regular basis is problematic in that it can not promptly collect monitoring information because a waiting period is required before monitoring information are collected.

A monitoring system for transmitting monitoring information each time it is acquired is problematic in that the system is heavily loaded due to the frequent transmission of monitoring information.

It is an object of the present invention to provide a distributed systems monitoring system and its method, a recording medium for recording therein an information monitoring program and a monitoring information integration program which are capable of promptly collecting monitoring information having a high degree of urgency.

### Means to Solve the Problems

A distributed systems monitoring system according to the present invention comprises: information monitoring units for acquiring monitoring information from respective monitoring targets and for notifying monitoring information collecting and integrating unit of the acquired monitoring information; and the monitoring information collecting and integrating unit for integrating the monitoring information acquired from the information monitoring units and for presenting the integrated monitoring information to a user.

The information monitoring unit comprises monitoring information acquisition means, monitoring information determination means, monitoring information holding means, urgent monitoring information transmitting means and general monitoring information transmitting means.

The monitoring information collecting and integrating unit comprises urgent monitoring information receiving means, general monitoring information requesting/receiving means, urgent monitoring information creation means, urgent monitoring information notification means, monitoring information integrating means, integrated monitoring information holding means, and monitoring information presentation means.

The information monitoring unit acquires monitoring information from the monitoring targets by means of the monitoring information acquisition means. The monitoring information determination means determines whether or not each item of monitoring information has a high degree of urgency. If the monitoring information has a high degree of urgency, then the urgent monitoring information transmitting means notifies the monitoring information collecting and integrating unit of the monitoring information. Otherwise, the monitoring information determination means stores the monitoring information in the monitoring information holding means, and transmits the monitoring information from the general monitoring information transmitting means each time that it receives a monitoring information request from the monitoring information collecting and integrating unit. The monitoring information collecting and integrating unit receives the urgent monitoring information by means of the urgent monitoring information receiving means, integrates by means of the urgent monitoring information creation means the urgent monitoring information with the general monitoring information that became available in the monitoring target in question by the time at which the notified urgent monitoring information became available, and notifies the user of the integrated monitoring information by means of the urgent monitoring information notification means. The monitoring information collecting and integrating unit transmits on a regular basis a general monitoring information request to the information monitoring unit from the general monitoring information requesting/receiving means. Upon receipt of the general monitoring information from the information monitoring units, the monitoring information collecting and integrating unit integrates by means of the monitoring information integrating means the general monitoring information from each monitoring unit and stores the integrated general monitoring information in the integrated monitoring information holding means. Further, upon receipt of a monitoring information presentation request from the user, the monitoring information collecting and integrating unit presents, by means of the monitoring information presentation means the general monitoring information held in the integrated monitoring information holding means, to the user.

According to the present invention, monitoring information are classified according to the degree of urgency thereof, and monitoring information having a high degree of urgency is promptly notified to the monitoring information collecting and integrating unit, while monitoring information having a low degree of urgency is notified to the monitoring information collecting and integrating unit at regular time intervals. Thus, compatibility between the attainment of the immediacy of monitoring and the reduction of loads on monitoring target systems is assured. At this time, it is likely that there arises a problem due to the difference in acquisition time between monitoring information having a high degree of urgency and other monitoring information. However, this problem can be avoided by acquiring monitoring information having a low degree of urgency separately.

The present invention provides the following advantages:

Firstly, since it is determined whether or not the monitoring information has a high degree of urgency, and since the monitoring information having a high degree of urgency is notified to the monitoring information collecting and integrating unit, the monitoring information that has a high degree of urgency can be promptly collected.

Secondly, since it is determined whether or not the monitoring information has a high degree of urgency, and since the monitoring information having a low degree of urgency is notified on a regular basis to the monitoring information collecting and integrating unit, the monitoring target systems can be monitored without imposing a heavy load thereon.

Thirdly, since the monitoring information collecting and integrating unit has the functionality to integrate monitoring information of plural monitoring targets, monitoring information of plural monitoring targets can be monitored in a unified manner.

Fourthly, the urgent monitoring information creation means has the functionality to synchronize urgent monitoring information and general monitoring information with each other, monitoring information having a high degree of urgency and other monitoring information can be monitored in an unified manner

### BRIEF DESCRIPTION OF THE DRAWINGS

FIG. 1 is a block diagram of a distributed systems monitoring system according to a related art.

FIG. 2 is a block diagram of a distributed systems monitoring system according to a first exemplary embodiment of the present invention.

FIG. 3 is a flowchart illustrating the operation of an information monitoring unit.

FIG. 4 is a flowchart illustrating the operation of a monitoring information collecting and integrating unit.

FIG. 5 is a flowchart illustrating the operation of a monitoring information collecting and integrating unit.

FIG. 6 is a flowchart illustrating the operation of a monitoring information collecting and integrating unit.

FIG. 7 is a block diagram of a distributed systems monitoring system according to a second exemplary embodiment of the present invention.

FIG. 8 is a diagram illustrating specific examples of a monitoring target.

FIG. 9 is a diagram illustrating causal information that is to be registered in a causal information holding section in the monitoring information collecting and integrating unit.

FIG. 10 is a diagram illustrating processing that occurs in monitoring targets 1 and 2.

FIG. 11 is a diagram illustrating information that is collected by a monitoring information acquisition section in association with processing that occurred in monitoring targets 1 and 2.

FIG. 12 is a diagram illustrating information that is to be held in an integrated monitoring information holding section after arranging their orders wherein the existence of cause information that corresponds to said information has been recognized.

FIG. 13 is a diagram illustrating processing that continuously occurs in monitoring units 1 and 2.

FIG. 14 is a diagram illustrating information that is collected by the monitoring information acquisition section and that is determined to be general monitoring information and that is then stored in monitoring information holding section by monitoring information determination section.

FIG. 15 is a diagram illustrating information that is to be held in the integrated monitoring information holding section after arranging their orders wherein the existence of cause information and existence of result information in the causal information that corresponds to said information have been recognized.

FIG. 16 is a diagram illustrating processing that continuously occurs in monitoring units 1 and 2.

FIG. 17 is a diagram illustrating information that are to be held in the integrated monitoring information holding section after arranging their orders in association with the processing shown in FIG. 16.

FIG. 18 is a diagram illustrating occurrence of a timeout during the time when processing 3 is performed in monitoring targets 1 and 2.

FIG. 19 is a diagram illustrating observation information that is held in the monitoring information holding section when a timeout occurs during the time when processing 3 is performed in monitoring targets 1 and 2.

FIG. 20 is a diagram illustrating general monitoring information that is to be stored in an integrated monitoring information holding section by a monitoring information integrating section.

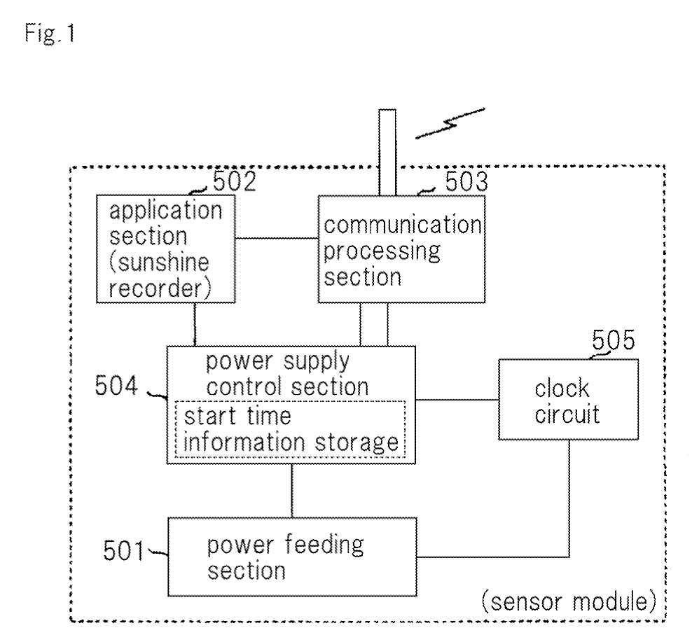

### EXPLANATION OF SYMBOLS

1, 2, 10-1, 10-2 monitoring target
20-1, 20-2 information monitoring unit
21 monitoring information acquisition section
22 monitoring information determination section
23 monitoring information holding section
24 urgent monitoring information transmitting section
25 general monitoring information transmitting section
30, 30′ monitoring information collecting and integrating unit
31 urgent monitoring information receiving section
32 general monitoring information requesting/receiving section
33 urgent monitoring information creation section
34 monitoring information integrating section
35 causal information holding section
36 integrated monitoring information holding section
37 urgent monitoring information notification section
38 monitoring information presentation section

### BEST MODE FOR CARRYING OUT THE INVENTION

A best mode for carrying out the invention will now be described in detail with reference to the drawings.

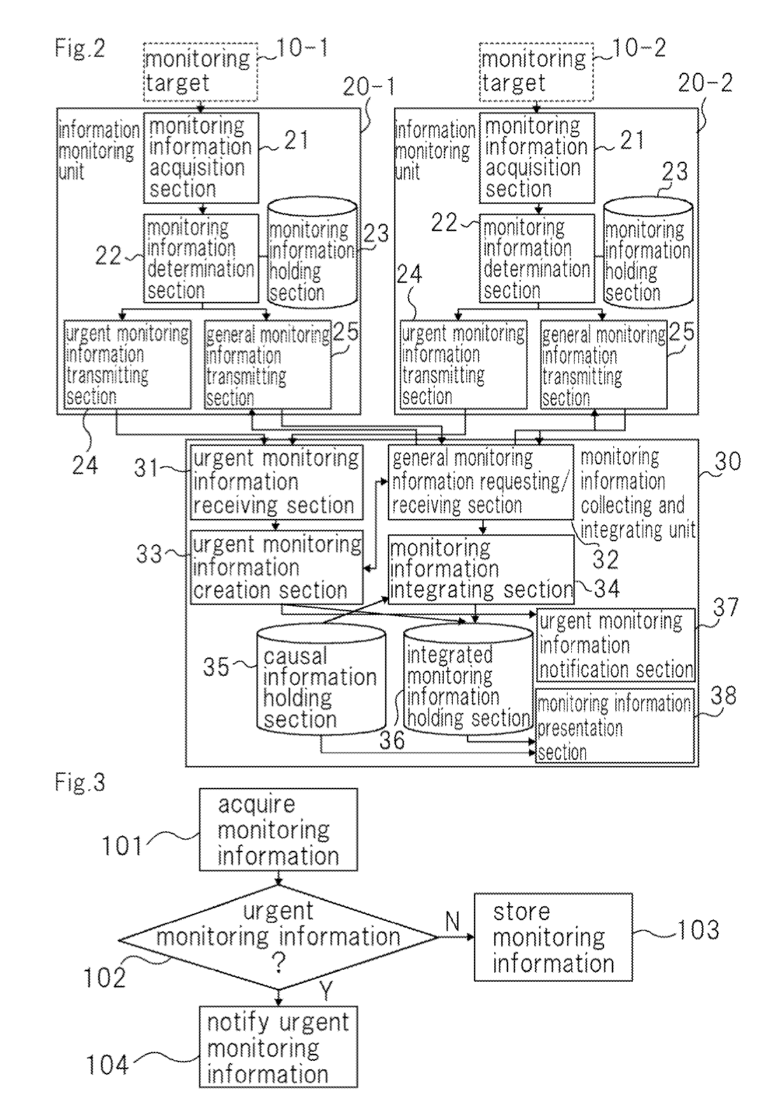

Referring now to FIG. 2, a distributed systems monitoring system according to a first exemplary embodiment of the present invention comprises: information monitoring units 20-1, 20-2 for acquiring monitoring information from respective monitoring targets 10-1, 10-2, and for notifying monitoring information collecting and integrating unit 30 of the acquired monitoring information; and monitoring information collecting and integrating unit 30 for integrating the monitoring information acquired from information monitoring units 20-1, 20-2, and for presenting the integrated monitoring information to a user.

Information monitoring units 20-1 and 20-2 each comprises monitoring information acquisition section 21, monitoring information determination section 22, monitoring information holding section 23, urgent monitoring information transmitting section 24 and general monitoring information transmitting section 25.

Monitoring information collecting and integrating unit 30 comprises urgent monitoring information receiving section 31, general monitoring information requesting/receiving section 32, urgent monitoring information creation section 33, monitoring information integrating section 34, causal information holding section 35, integrated monitoring information holding section 36, urgent monitoring information notification section 37 and monitoring information presentation section 38.

Rough operations of these sections are as follows.

Monitoring information acquisition section 21 monitors operations of monitoring targets 10-1, 10-2, collects monitoring information and notifies monitoring information determination section 22 of the monitoring information. Monitoring information determination section 22 determines whether or not the monitoring information has a high degree of urgency. If the monitoring information has a high degree of urgency (urgent monitoring information), then monitoring information determination section 22 notifies urgent monitoring information transmitting section 24 of the urgent monitoring information. Otherwise, monitoring information determination section 22 stores the monitoring information (general monitoring information) in monitoring information holding section 23. Monitoring information holding section 23 stores therein the monitoring information that have been determined as general monitoring information by monitoring information determination section 22. Urgent monitoring information transmitting section 24 transmits the monitoring information, that have been determined as urgent monitoring information by monitoring information determination section 22, to urgent monitoring information receiving section 31. General monitoring information transmitting section 25 transmits the general monitoring information stored in monitoring information holding section 23 to general monitoring information requesting/receiving section 32 in accordance with the request therefrom.

Urgent monitoring information receiving section 31 notifies urgent monitoring information creation section 33 of the urgent monitoring information received from each urgent monitoring information transmitting section 24. General monitoring information requesting/receiving section 32 requests the transmission of the general monitoring information from each general monitoring information transmitting section 25 on a regular basis, and notifies monitoring information integrating section 34 of the acquired general monitoring information. Further, in accordance with the request from urgent monitoring information creation section 33, general monitoring information requesting/receiving section 32 receives from general monitoring information transmitting section 25 general monitoring information that became available in the monitoring target in question by the time at which the notified urgent monitoring information became available, and notifies urgent monitoring information creation section 33 of the received general monitoring information. Urgent monitoring information creation section 33 integrates the urgent monitoring information that have been received at urgent monitoring information receiving section 31 with the general monitoring information that had been received at general monitoring information requesting/receiving section 32 and that became available by the time at which the urgent monitoring information became available, stores the resultant monitoring information in integrated monitoring information holding section 36, and at the same time urgent monitoring information notification section 37 notifies the user of the resultant monitoring information. Monitoring information integrating section 34 integrates using causal information general monitoring information that is obtained from information monitoring units 20-1, 20-2 on a regular basis, and stores the integrated general monitoring information in integrated monitoring information holding section 36. Causal information holding section 35 holds therein causal information. Integrated monitoring information holding section 36 holds therein the integrated monitoring information. Urgent monitoring information notification section 37 notifies the user of the urgent monitoring information that is created by urgent monitoring information creation section 33. Monitoring information presentation section 38 correlates the general monitoring information that is stored in integrated monitoring information holding section 36 and that is integrated in monitoring information integrating section 34, with the causal information held in causal information holding section 35, and presents the general monitoring information that have been correlated with the causal information to the user.

The overall operation of the present exemplary embodiment will next be explained in detail with reference to FIG. 2 and the flowcharts in FIGS. 3 to 6.

First, monitoring information acquisition section 21 that monitors operations of monitor targets 10-1, 10-2 detects monitoring information (step 101 in FIG. 3). Next, monitoring information determination section 22 analyses the monitoring information and determines whether or not the monitoring information is information having a high degree of urgency (step 102). If the monitoring information is information having a high degree of urgency, that is, urgent monitoring information, then urgent monitoring information transmitting section 24 notifies urgent monitoring information receiving section 31 of the urgent monitoring information (step 104). If the monitoring information is general information not having a high degree of urgency, that is, general monitoring information, then the general monitoring information is stored in monitoring information holding section 23 (step 103).

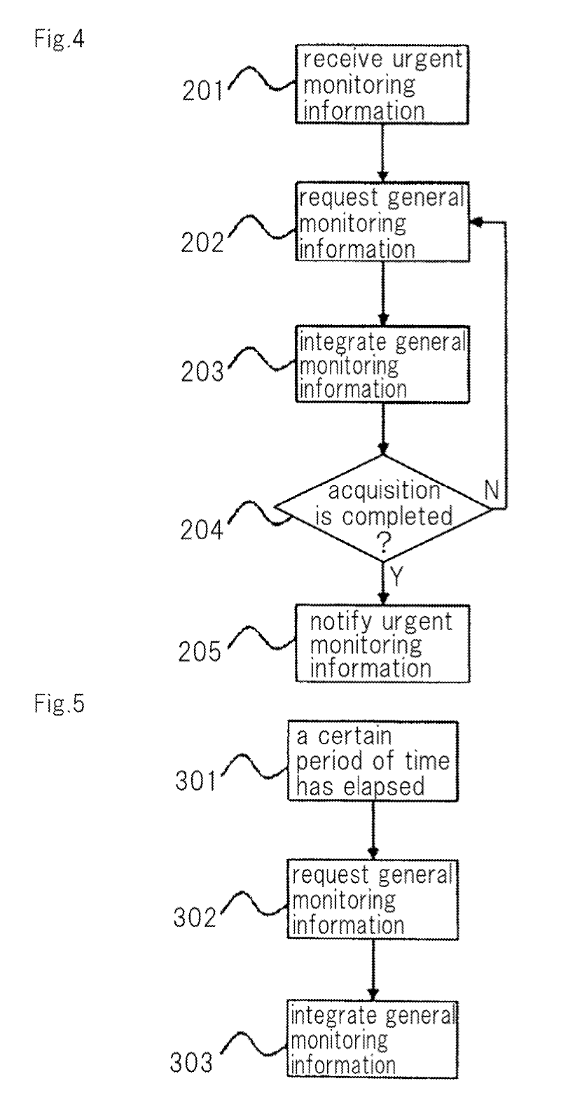

When urgent monitoring information receiving section 31 receives urgent monitoring information (step 201 in FIG. 4), then urgent monitoring information creation section 33 transmits a general monitoring information request to all general monitoring information transmitting sections 25 through general monitoring information requesting/receiving section 32 (step 202). In response to the request, general monitoring information transmitting section 25 transmits the general monitoring information stored in monitoring information holding section 23 to general monitoring information requesting/receiving section 32. When general monitoring information have been collected from all information monitoring units 20-1, 20-2, urgent monitoring information creation section 33 integrates, with the received urgent monitoring information, the collected general monitoring information that became available by the time at which the urgent monitoring information became available, and stores the integrated monitoring information in integrated monitoring information holding section 36 (step 203). It is now determined whether or not all the general monitoring information that became available by the time at which the urgent monitoring information received at step 201 is stored in integrated monitoring information holding section 306 (step 204). If the information is not stored, processing from step 202 are repeated. If the information is stored y are, urgent monitoring information notification section 37 notifies the user of the urgent monitoring information and the general monitoring information that became available by the time at which the urgent monitoring information became available (step 205). This allows the user to know the urgent monitoring information and status of the monitoring target in question at the time that the urgent monitoring information became available.

When a certain period of time has elapsed in monitoring information collecting and integrating section 30 (step 301 in FIG. 5), general monitoring information requesting/receiving section 32 transmits a general monitoring information request to all general monitoring information transmitting sections 25 (step 302). In response to the request, general monitoring information transmitting section 25 notifies general monitoring information requesting/receiving section 32 of the general monitoring information stored in monitoring information holding section 23. When general monitoring information has been collected from all information monitoring units 20-1, 20-2, monitoring information integrating section 34 arranges the orders of the general monitoring information using the causal information held in causal information holding section 35 and then stores the same in integrated monitoring information holding section 306 (step 303).

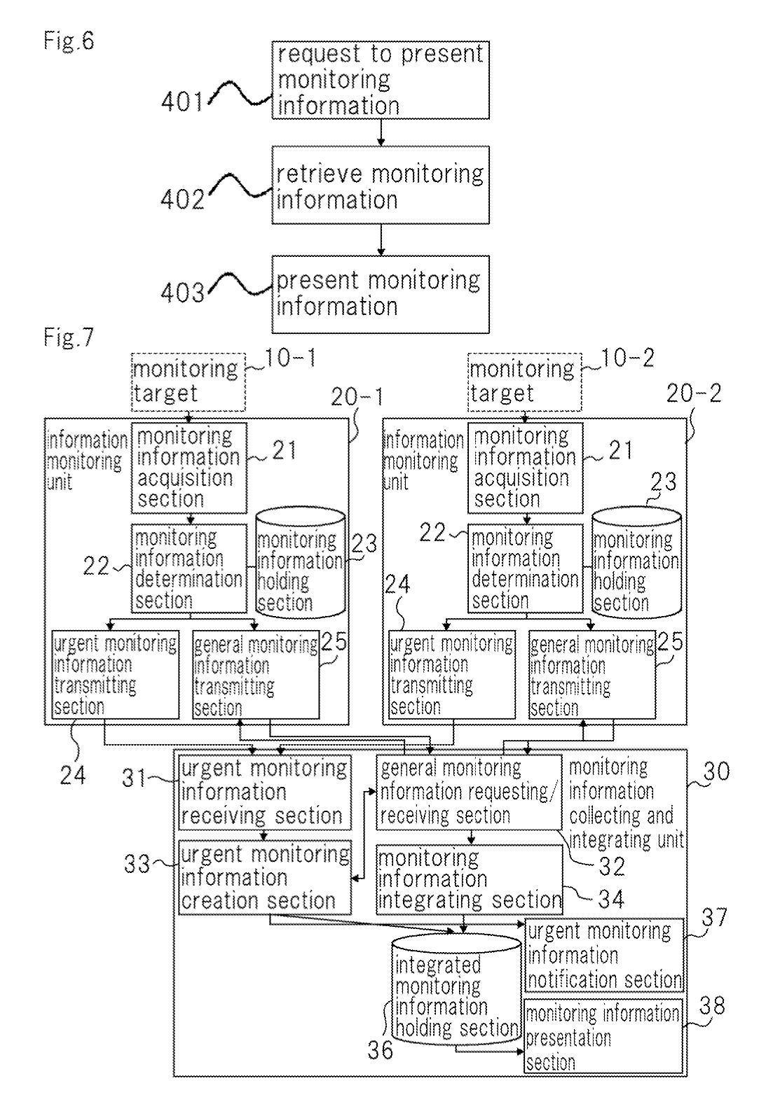

When the user requests monitoring information presentation section 38 to present the monitoring information (step 401 in FIG. 6), monitoring information presentation section 38 correlates the monitoring information held in integrated monitoring information holding section 36, with the causal information held in causal information holding section 35 (step 402), and presents the monitoring information that is correlated with causal information to the user (step 403).

Although the number of the information monitoring unit is two in the present exemplary embodiment, it may be three or more.

The effects of the present exemplary embodiment are as follows.

The distributed systems monitoring system according to the present exemplary embodiment is configured such that information monitoring units 20-1 and 20-2 notify monitoring information collecting and integrating unit 30 of urgent monitoring information and general monitoring information on different paths. Accordingly, the urgent monitoring information can be promptly notified to monitoring information collecting and integrating unit 30 and a load that is imposed on the monitoring targets when notifying monitoring information does not greatly affect the monitoring targets.

Further, the distributed systems monitoring system according to the present exemplary embodiment is configured such that information monitoring units 20-1 and 20-2 collect monitoring information of respective monitoring targets, and monitoring information collecting and integrating unit 30 integrates the plural items of monitoring information using causal information. Accordingly, monitoring information of plural monitoring targets can be presented to the user in a unified form.

Moreover, the distributed systems monitoring system according to the present exemplary embodiment is configured such that information monitoring units 20-1 and 20-2 collects, when notifying urgent monitoring information, general monitoring information that was collected by the time of the occurrence of the urgent monitoring information, and monitoring information collecting and integrating unit 30 synchronizes the urgent monitoring information and the general monitoring information with each other. Accordingly, monitoring information of plural monitoring targets can be presented to the user in a unified form.

Referring to FIG. 7, a distributed systems monitoring system according to a second exemplary embodiment of the present invention comprises: information monitoring units 20-1 and 20-2 for acquiring monitoring information from respective monitoring targets 10-1 and 10-2, and for notifying monitoring information collecting and integrating unit 30′ of the acquired monitoring information; monitoring information collecting and integrating unit 30′ for integrating the monitoring information acquired from information monitoring units 20-1 and 20-2, and for presenting the integrated monitoring information to the user.

Information monitoring units 20-1 and 20-2 have the same configuration as those of information monitoring units 20-1 and 20-2 in the first exemplary embodiment.

Monitoring information collecting and integrating unit 30′ comprises urgent monitoring information receiving section 31, general monitoring information requesting/receiving section 32, urgent monitoring information creation section 33, monitoring information integrating section 34′, integrated monitoring information holding section 36, urgent monitoring information notification section 37 and monitoring information presentation section 38. Monitoring information collecting and integrating unit 30′ differs from monitoring information collecting and integrating unit 30 in the first exemplar embodiment in that it does not have casual information holding section 35, and instead monitoring information integrating section 34′ has processing that differs in part from that of monitoring information integrating section 34 in the first exemplary embodiment. That is, when collecting general monitoring information from both information monitoring units 20-1 and 20-2, then monitoring information integrating section 34′ stores the general monitoring information in integrated monitoring information holding section 36 after arranging the order of the general monitoring information using information of the time at which the general monitoring information became available. This allows the user to know the status of the entire monitoring targets at the time when the general monitoring information became available.

The effects of the present exemplary embodiment are as follows.

The distributed systems monitoring system according to the present exemplary embodiment is configured such that information monitoring units 20-1 and 20-2 notify monitoring information collecting and integrating unit 30′ of urgent monitoring information and general monitoring information on different paths. Accordingly, the urgent monitoring information can be promptly notified to monitoring information collecting and combining unit 30′ and a load that is imposed on the monitoring targets when notifying the monitoring information do not greatly affect the monitoring targets.

Further, the distributed systems monitoring system according to the present exemplary embodiment is configured such that monitoring information collecting and integrating unit 30′ collects and integrates monitoring information of plural monitoring targets. Accordingly, monitoring information of plural monitoring targets can be presented to the user in a unified form.

Moreover, the distributed systems monitoring system according to the present exemplary embodiment is configured such that monitoring information collecting and integrating unit 30′ integrates monitoring information of plural monitoring targets based on information of the times at which the monitoring information became available, for example, in the order of the times at which the monitoring information became available. Accordingly, if the time information is correct, plural items of monitoring information can be presented to the user in a unified form, even if there is no relevant information among the plural monitoring targets.

Moreover, the distributed systems monitoring system according to the present exemplary embodiment is configured such that information monitoring units 20-1 and 20-2 collect, when notifying urgent monitoring information, general monitoring information that was collected by the time at which the urgent monitoring information became available, and monitoring information collecting and integrating unit 30′ synchronizes the urgent monitoring information and the general monitoring information with each other. Accordingly, monitoring information of plural monitoring targets can be presented to the user in a unified form.

Operation of the present exemplary embodiment will next be explained using a specific example.

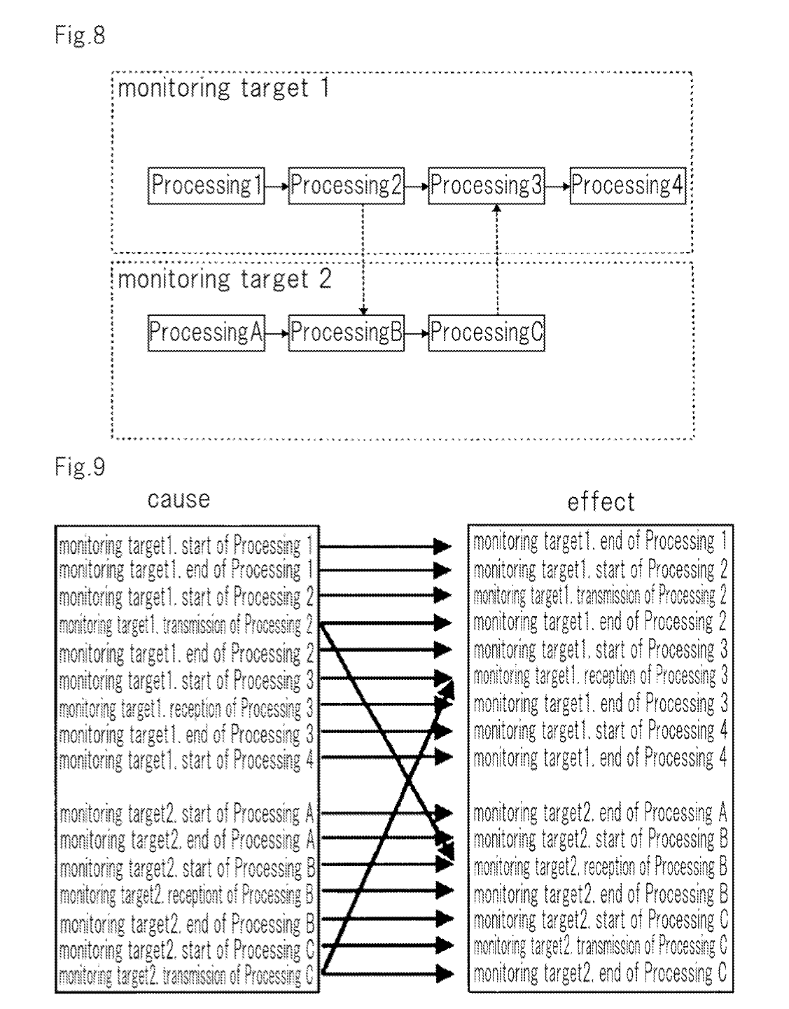

As shown in FIG. 8, it is assumed that there exist two monitoring targets 1 and 2 each performing processing and that there are relationships between monitoring targets 1 and 2 (from Processing 2 to Processing B, from Processing C to Processing 3).

In this case, information monitoring units 20-1 and 20-2 are deployed for respective monitoring targets 1 and 2. Information monitoring units 20-1, 20-2 each monitor the start and end of each processing that is performed in each system of monitoring units 2-1 and 2-2, transmission and reception of messages to and from another system, and detects these events as general monitoring information. Further, when each processing operation is not completed even after the expiration of a fixed time period from the start of the processing operation, information monitoring units 20-1 and 20-2 each consider this as the occurrence of a timeout, and detect this as urgent monitoring information.

Causal information as shown in FIG. 9 is previously registered in causal information holding section 35 in monitoring information collecting and integrating unit 30.

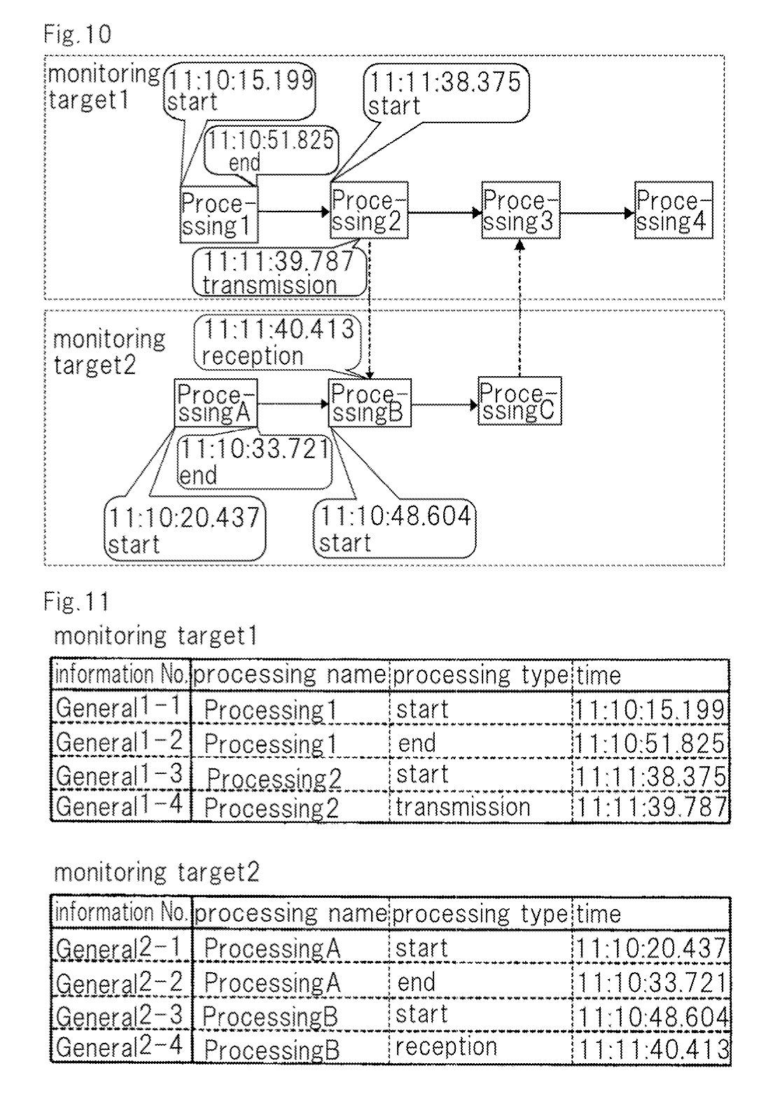

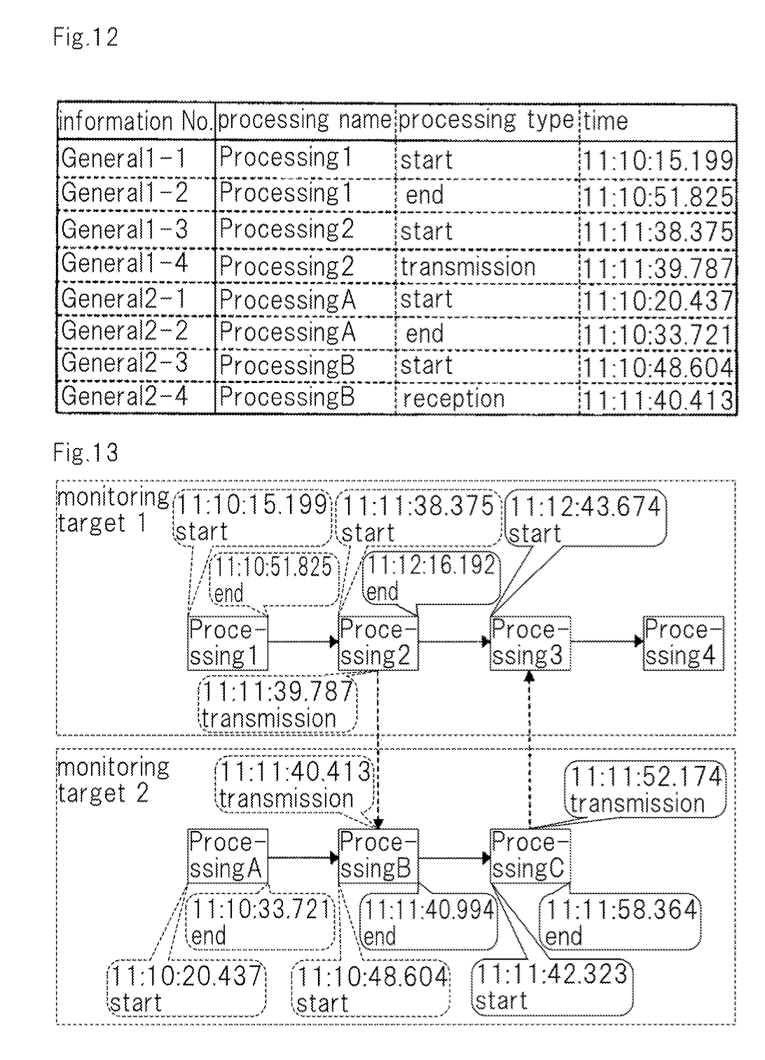

When processing as shown in FIG. 10 occurs in monitoring targets 1 and 2, monitoring information acquisition section 21 acquires information shown in FIG. 11, and monitoring information determination section 22 determines that this information is general monitoring information and stores the same in monitoring information holding section 23. On the other hand, general monitoring information requesting/receiving section 32 transmits at regular time intervals a general monitoring information request to general monitoring information transmitting section 25 for information monitoring units 20-1 and 20-2. General monitoring information transmitting section 25 notifies general monitoring information requesting/receiving section 32 of the information shown in FIG. 11 that are stored in monitoring information holding section 23. Monitoring information integrating section 34 analyzes this general monitoring information based on the causal information stored in causal information holding section 35 and determines whether or not there exist information comparable to a cause in the causal information and information comparable to a result in the causal information that corresponds to the cause. General monitoring information which is comparable to a cause and to a result corresponding to the cause in the causal information are arranged in terms of order and then stored in integrated monitoring information holding section 36, as shown in FIG. 12. When observed information of general monitoring information 1-4 is not acquired due to a delay in the operation of monitoring information acquisition section 21 and the like, it is determined from the causal information that information responsible for observed general monitoring information 24 is not acquired. Since it is not clear at this time whether this is due to the failure of the monitoring target or due to the delay in the operation of monitoring information acquisition section 21, the processing of observed general monitoring information 24 is suspended and is again performed by monitoring information integrating section 34 at the next acquisition of general monitoring information.

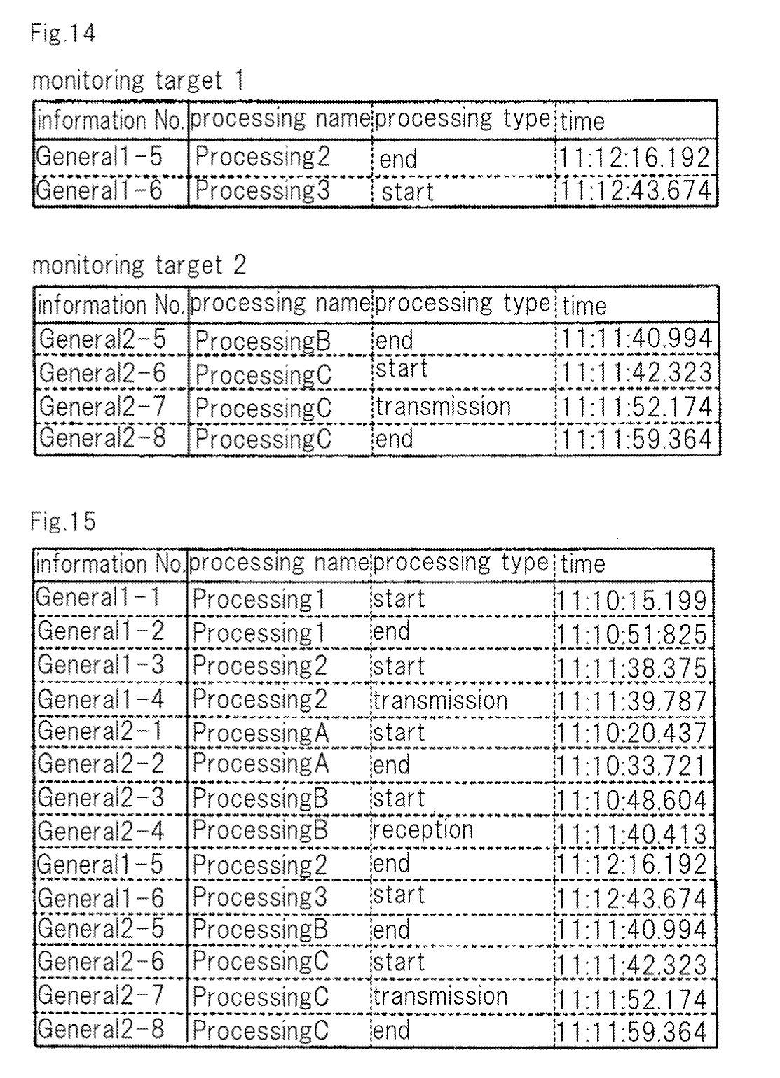

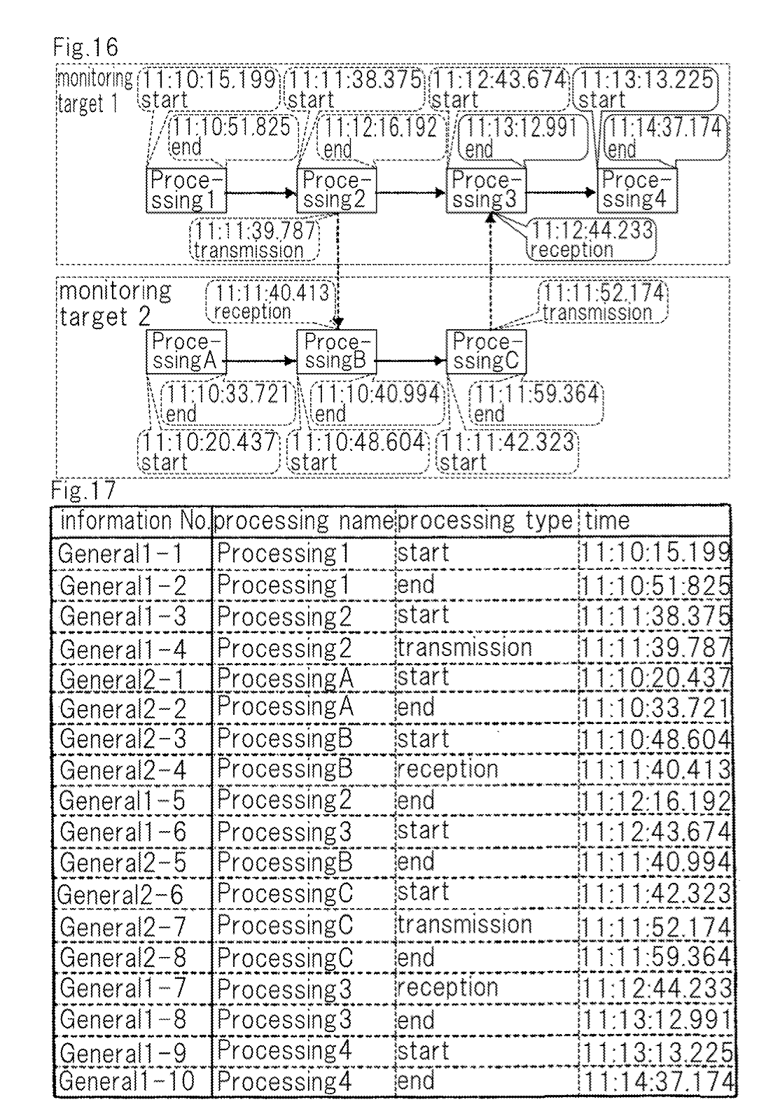

When processing is subsequently performed in monitoring targets 1 and 2 as shown in FIG. 13, monitoring information acquisition section 21 collects information shown in FIG. 14 and monitoring information determination section 22 determines that this information is general monitoring information and stores the same in monitoring information holding section 23. Then, general monitoring information requesting/receiving section 32 transmits a general monitoring information request to general monitoring information transmit sections 25 for monitoring targets 1 and 2, which in turn notify general monitoring information requesting/receiving section 32 of the information shown in FIG. 14 that is stored in monitoring information holding section 23. Monitoring information integrating section 34 analyzes this general monitoring information based on the causal information stored in causal information holding section 35 and determines whether or not there exists information comparable to a cause in the causal information and information comparable to a result in the causal information that corresponds to the cause. General monitoring information which is comparable to a cause and to a result corresponding to the cause in the causal information is arranged in terms of order and then stored in integrated monitoring information holding section 36, as shown in FIG. 15. When processing is continuously performed in monitoring targets 1 and 2, as shown in FIG. 16, to the last, general monitoring information which is comparable to a cause and to a result corresponding to the cause in the causal information is similarly arranged in terms of order and is then stored in integrated monitoring information holding section 36, as shown in FIG. 17.

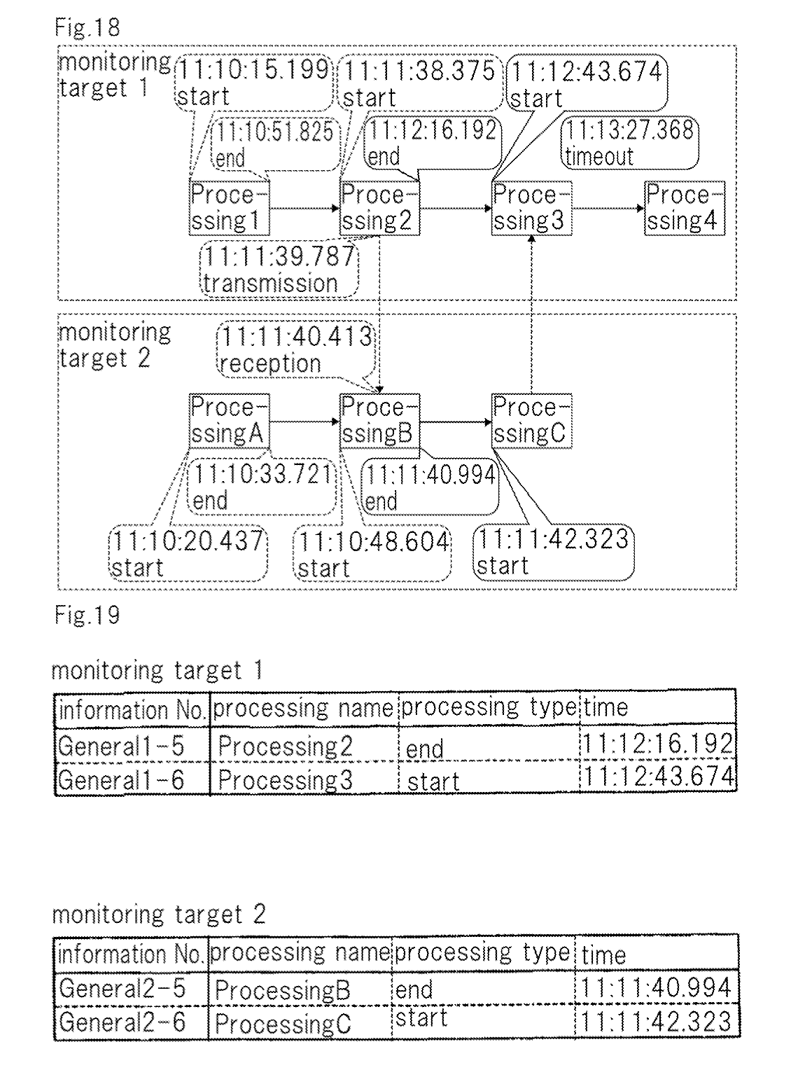

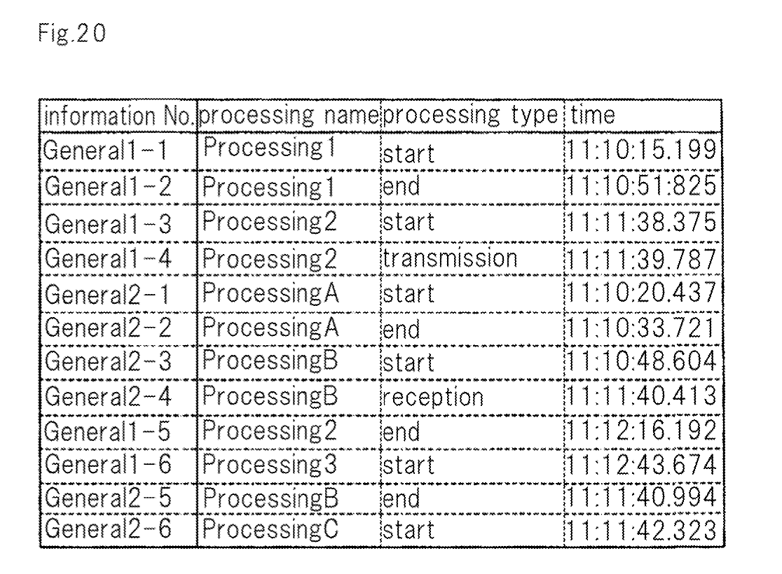

Now consider a case where monitoring targets 1 and 2 are in states shown in FIGS. 10 and 12, and thereafter a timeout occurs during the time when processing 3 is performed, as shown in FIG. 18. At this time, observed information as shown in FIG. 19 is held in monitoring information holding section 23. Since monitoring information determination section 22 determines that the timeout is urgent monitoring information, urgent monitoring information transmitting section 24 transmit the urgent monitoring information to urgent monitoring information receiving section 31. Next, urgent monitoring information creation section 33 transmits a general monitoring information request to all general monitoring information transmitting sections 25 through general monitoring information requesting/receiving section 32 to acquire general monitoring information as shown in FIG. 19 that is stored in monitoring information holding section 23. The general monitoring information are stored in integrated monitoring information holding section 36, as shown in FIG. 20, by monitoring information integrating section 34. Thus, general monitoring information at the time when the urgent monitoring information became available is held in integrated monitoring information holding section 36, and urgent monitoring information notification section 37 notifies the user of the urgent monitoring information.

The user may request monitoring information presentation section 38 to present the monitoring information to him or her at any time. Monitoring information presentation section 38 creates information to be presented to the user from the information held in causal information holding section 35 and in integrated monitoring information holding section 36, and presents the created information to the user. The created information may be presented in a form, by way example, as shown in FIGS. 12, 15 and 20.

The functions of the information monitoring unit and the monitoring information collecting and integrating unit as explained hereinabove may be carried out by recording a program for performing the functions of the processing operation in a computer-readable recording medium, and then by reading the program thus recorded into a computer. The computer-readable recording medium may refer to a recording medium such as a flexible disk, a CD-ROM, or the like, or a recording medium such as a hard disk drive incorporated in a computer system. The computer-readable recording medium may also refer to a medium for dynamically holding a computer program for a short period of time, e.g., a transmission medium or a transmission wave, for use in applications for transmitting the program through the Internet, or a medium for holding the program for a certain period of time, e.g., volatile memory in a computer system which operates as a server in such an application.

While preferred exemplary embodiments of the present invention have been described using specific terms, such description is for illustrative purposes only, and it is to be understood that changes and variations may be made without departing from the spirit or scope of the following claims.

This application is based upon and claims the benefit of priority from Japanese patent application No. 2007-084568 filed on Mar. 28, 2007, the disclosure of which is incorporated herein in its entirety by reference.

### INDUSTRIAL APPLICABILITY

The present invention is applicable to monitoring the entire systems in a unified way wherein the systems operate in a coordinated manner.

1. A distributed systems monitoring system comprising:
a plurality of information monitoring units; and
a monitoring information collecting and integrating unit for collecting monitoring information from said plurality of information monitoring units, for integrating the collected monitoring information, and for presenting the integrated monitoring information to a user,
wherein said information monitoring unit includes: monitoring information acquisition means for acquiring monitoring information from a monitored target; monitoring information determination means for determining whether or not the acquired monitoring information is urgent; monitoring information holding means for temporarily holding monitoring information as general monitoring information that is determined to be not urgent; urgent monitoring information transmitting means for transmitting to said monitoring information collecting and integrating unit monitoring information as urgent monitoring information that is determined to be urgent; and general monitoring information transmitting means for transmitting said general monitoring information held in said monitoring information holding means to said monitoring information collecting and integrating unit at the request of the latter; and
wherein said monitoring information collecting and integrating unit includes: urgent monitoring information receiving means for receiving said urgent monitoring information from each of said information monitoring units; general monitoring information requesting/receiving means for requesting and receiving said general monitoring information from each of said information monitoring units; urgent monitoring information creation means for integrating the urgent monitoring information received by said urgent monitoring information receiving means with the general monitoring information that was collected by means of said general monitoring information requesting/receiving means and that became available by the time when said urgent monitoring information became available; urgent monitoring information notification means for notifying said user of the urgent monitoring information that has been integrated with said general monitoring information; monitoring information integrating means for integrating plural items of general monitoring information that are received by said general monitoring information requesting/receiving means on a regular basis; integrated monitoring information holding means for holding the integrated general monitoring information; and monitoring information presentation means for presenting the general monitoring information held in said integrated monitoring information holding means to the user.

2. The distributed systems monitoring system according to claim 1, wherein said monitoring information integrating means integrates said plural items of general monitoring information using causal information.

3. The distributed systems monitoring system according to claim 1, wherein said monitoring information integrating means arranges the order of said plural items of general monitoring information for integration by using information of times when said general monitoring information became available.

4. A method of monitoring distributed systems, said method being performed in a distributed systems monitoring system comprising a plurality of information monitoring units; and a monitoring information collection and integration unit for collecting monitoring information from said plurality of information monitoring units, for integrating the collected monitoring information, and for presenting the integrated monitoring information to a user, said method comprising:
at said information monitoring unit,
acquiring monitoring information from a monitoring object;
determining whether or not the acquired monitoring information is urgent;
temporarily holding in monitor information holding means monitoring information as general monitoring information that is determined to be not urgent; and
transmitting to said monitoring information collection and integration unit monitoring information as urgent monitoring information that is determined to be urgent;
at said monitoring information collection and integration unit,
receiving said urgent monitoring information from each of said information monitoring units;
collecting said general monitoring information from each of said information monitoring units that became available in the monitoring target in question by the time when said urgent monitoring information became available;
integrating said urgent monitoring information with the general monitoring information that became available by the time when said urgent monitoring information became available;
notifying said user of the urgent monitoring information that have been integrated with said general monitoring information;
collecting general monitoring information from each of said information monitoring units on a regular basis;
integrating plural items of general monitoring information that have been collected on a regular basis; and holding the integrated general monitoring information in an integrated monitoring information holding means; and
presenting the general monitoring information held in said integrated monitoring information holding means to the user.

5. The method of monitoring distributed systems according to claim 4, wherein said integrating plural items of general monitoring information that have been collected on a regular basis includes integrating plural items of general monitoring information by using causal information.

6. The method of monitoring distributed systems according to claim 4, wherein said integrating plural items of general monitoring information that have been collected on a regular basis includes arranging the order of said plural items of general monitoring information for integration by using information of times when said general monitoring information became available.

7. A computer-readable storage medium storing an information monitoring program for causing a computer to perform the monitoring of information, said monitoring program comprising the procedures of:
acquiring monitoring information from a monitored target;
determining whether or not the acquired monitoring information is urgent;
temporarily holding in a monitoring information holding means monitoring information as general monitoring information that is determined to be not urgent;
transmitting monitoring information as urgent monitoring information that is determined to be urgent; and
transmitting said general monitoring information held in said monitoring information holding means by request.

8. A computer-readable storage medium storing a monitoring information collecting and integrating program for causing a computer to collect and integrate monitoring information, said program comprising the procedures of:
receiving urgent monitoring information;
integrating said urgent monitoring information with general monitoring information that became available by the time when said urgent monitoring information became available;
notifying a user of the urgent monitoring information that has been integrated with said general monitoring information;
collecting general monitoring information from information monitoring units on a regular basis;
integrating plural items of general monitoring information that have been collected on a regular basis; and holding the integrated general monitoring information in an integrated monitoring information holding means; and
presenting the general monitoring information held in said integrated monitoring information holding means to the user.

9. The recording medium for storing therein a monitoring information collecting and integrating program according to claim 8, wherein said integrating plural items of general monitoring information that are collected on a regular basis includes integrating plural items of general monitoring information by using causal information.

10. The recording medium for storing therein a monitoring information collecting and integrating program according to claim 8, wherein said integrating plural items of general monitoring information that are collected on a regular basis includes arranging the order of said plural items of general monitoring information for integration by using information of times at the time when said general monitoring information became available.
